(19) United States
(12) Patent Application Publication
(10) Pub. No.: US 2018/0285448 A1
(43) Pub. Date: Oct. 4, 2018

(54) PRODUCING PERSONALIZED SELECTION OF APPLICATIONS FOR PRESENTATION ON WEB-BASED INTERFACE

(71) Applicant: Google LLC, Mountain View, CA (US)

(72) Inventors: Chih-Chun Chia, Santa Clara, CA (US); Yuan Wang, Santa Clara, CA (US); Tiansheng Yao, Mountain View, CA (US); Chun How Tan, Taman Sakeh Baru (MY); Matthew MacMahon, Sunnyvale, CA (US)

(21) Appl. No.: 15/478,970

(22) Filed: Apr. 4, 2017

(51) Int. Cl. G06F 17/30; G06N 3/02; G06N 5/04

(52) U.S. Cl. CPC G06F 17/30675; G06F 17/30448; G06F 17/30684; G06N 5/04; G06F 17/30598; G06N 3/02; G06F 17/30958

(57) ABSTRACT

A personalized selection of applications for presentation on a web-based interface can be produced. A first vector can represent one or more first words from a first query. A second query, including the one or more first words and one or more second words, can be transmitted in response to a first determination that a measure of similarity between the first vector and a second vector, which represents the one or more second words, is greater than a threshold. The second vector can be obtained from a knowledge base. A response to the second query can include an identification of a first application. A cluster of applications, including the first application and a second application, can be generated in response to a second determination of an existence of a relationship between the first application and the second application. The personalized selection of applications can be produced based on the cluster.

### TECHNICAL FIELDS

The disclosed subject matter is related to at least the technical fields of information retrieval systems, distributed computing systems, natural language processes, semantic-search processes, word embedding processes, and formal concept analysis processes.

### BACKGROUND

Application software products (i.e., applications) have been developed to perform a variety of functions related to, for example, word processing, spreadsheets, slide show presentations, database management, electronic mail, Internet access, business productivity, educational assistance, health and fitness management, providing digital content (such as, for example, text, pictures, audio, video, and electronic games), navigation, text messaging, access to social media networks, etc. The advancement of electronic communication network bandwidth capabilities in the last decade has enabled the delivery of applications to shift from being primarily performed via physical data storage devices (such as, for example, floppy disks, compact discs, digital versatile discs, and Universal Serial Bus flash drives) to being performed via online distribution in which developers can upload applications from an application host platform to a digital distribution platform, and users can download applications from the digital distribution platform to a user device. The digital distribution platform can be an application marketplace, online store, or other distribution system.

### BRIEF SUMMARY

According to an implementation of the disclosed subject matter, in a method for producing a personalized selection of applications for presentation on a web-based interface, a first vector can be produced by a processor through a word embedding process. The first vector can represent one or more first words. The one or more first words can be from a first query. The first query can be a free-form text query. A second query can be transmitted, in response to a first determination, from the processor to a digital distribution platform. The second query can include the one or more first words and one or more second words. The first determination can be that a measure of similarity between the first vector and a second vector is greater than a threshold. The second vector can represent the one or more second words. A response to the second query, from the digital distribution platform, can be received by the processor. The response to the second query can include an identification of a first application. The first application can be available for distribution by the digital distribution platform. A cluster of applications can be generated, in response to a second determination, by the processor. The cluster of applications can include the first application and a second application. The second application can be available for distribution by the digital distribution platform. The second determination can be of an existence of a relationship between the first application and the second application. The personalized selection of applications can be produced, based on information about the cluster of applications, by the processor for presentation on the web-based interface for a user account associated with the first query.

According to an implementation of the disclosed subject matter, in a non-transitory computer-readable medium storing computer code for controlling a processor to cause the processor to produce a personalized selection of applications for presentation on a web-based interface, the computer code can include instructions to cause the processor to produce a first vector through a word embedding process. The first vector can represent one or more first words. The one or more first words can be from a first query. The first query can be a free-form text query. The computer code can include instructions to cause the processor to transmit, in response to a first determination, a second query to a digital distribution platform. The second query can include the one or more first words and one or more second words. The first determination can be that a measure of similarity between the first vector and a second vector is greater than a threshold. The second vector can represent the one or more second words. The computer code can include instructions to cause the processor to receive a response to the second query from the digital distribution platform. The response to the second query can include an identification of a first application. The first application can be available for distribution by the digital distribution platform. The computer code can include instructions to cause the processor to generate, in response to a second determination, a cluster of applications. The cluster of applications can include the first application and a second application. The second application can be available for distribution by the digital distribution platform. The second determination can be of an existence of a relationship between the first application and the second application. The computer code can include instructions to cause the processor to produce, based on information about the cluster of applications, the personalized selection of applications for presentation on the web-based interface for a user account associated with the first query.

According to an implementation of the disclosed subject matter, a system for producing a personalized selection of applications for presentation on a web-based interface can include a processor, communications circuitry, and a memory. The processor can be configured to produce, through a word embedding process, a first vector. The first vector can represent one or more first words. The one or more first words can be from a first query. The first query can be a free-form text query. The processor can be configured to determine that a measure of similarity between the first vector and a second vector is greater than a threshold. The second vector can represent one or more second words. The processor can be configured to determine an existence of a relationship between a first application and a second application. The first application and the second application can be available for distribution by a digital distribution platform. The processor can be configured to generate, in response to a first determination, a cluster of applications. The cluster of applications can include the first application and the second application. The first determination can be of the existence of the relationship. The processor can be configured to produce, based on information about the cluster of applications, the personalized selection of applications for presentation on the web-based interface for a user account associated with the first query. The communications circuitry can be configured to transmit, in response to a second determination, a second query to the digital distribution platform. The second query can include the one or more first words and the one or more second words. The second determination can be that the measure of similarity is greater than the threshold. The communications circuitry can be configured to receive, from the digital distribution platform, a response to the second query. The response to the second query can include an identification of the first application. The memory can be configured to store one or more first words, the first vector, the first query, the one or more second words, the second vector, the second query, the measure of similarity, the threshold, the response to the second query, and the information about the cluster of applications.

According to an implementation of the disclosed subject matter, a system for producing a personalized selection of applications for presentation on a web-based interface. The system can include means for producing, through a word embedding process, a first vector. The first vector can represent one or more first words. The one or more first words can be from a first query. The first query can be a free-form text query. The system can include means for transmitting, in response to a first determination, a second query to a digital distribution platform. The second query can include the one or more first words and one or more second words. The first determination can be that a measure of similarity between the first vector and a second vector is greater than a threshold. The second vector can represent the one or more second words. The system can include means for receiving, from the digital distribution platform, a response to the second query. The response to the second query can include an identification of a first application. The first application can be available for distribution by the digital distribution platform. The system can include means for generating, in response to a second determination, a cluster of applications. The cluster of applications can include the first application and a second application. The second application can be available for distribution by the digital distribution platform. The second determination can be of an existence of a relationship between the first application and the second application. The system can include means for producing, based on information about the cluster of applications, the personalized selection of applications for presentation on the web-based interface for a user account associated with the first query.

Additional features, advantages, and aspects of the disclosed subject matter are set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate aspects of the disclosed subject matter and together with the detailed description serve to explain the principles of aspects of the disclosed subject matter. No attempt is made to show structural details in more detail than may be necessary for a fundamental understanding of the disclosed subject matter and various ways in which it may be practiced.

FIG. 1 is a diagram illustrating an example of a user device and an information retrieval platform in which a web-based interface is used as a home page for a digital distribution platform.

FIG. 2 is a diagram illustrating an example of the user device and the information retrieval platform in which the web-based interface is used to facilitate a query.

FIG. 3 is a diagram illustrating an example of a distributed computing system in which the web-based interface, with a personalized selection of applications, can be produced according to the disclosed subject matter.

FIG. 4 is a diagram illustrating examples of data objects for applications, of a collection of data objects, in an implementation of the digital distribution platform.

FIG. 5 is a diagram illustrating examples of records in an implementation of an activity log database of the digital distribution platform.

FIGS. 6A and 6B are a flow diagram illustrating an example of a method for producing the personalized selection of applications for presentation on the web-based interface according to the disclosed subject matter.

FIG. 7 is a diagram illustrating an example of a vector, produced through a word embedding process, in which dimensions can represent a number of occurrences of a particular word in documents in a collection of documents.

FIG. 8 is a diagram illustrating an example of a vector, produced through a word embedding process, in which dimensions can represent other words and their displacement from a particular word in a context of a phrase.

FIG. 9 is a diagram illustrating an example of a vector, produced through a word embedding process, which can be an aggregate of vectors for words included in the one or more first words.

FIG. 10 is a diagram illustrating an example of some documents in the collection of documents referenced in the description of FIG. 7.

FIG. 11 is a diagram illustrating an example of a determination of similarity between document occurrence vectors.

FIG. 12 is a diagram illustrating an example of a determination of similarity between word context vectors.

FIG. 13 is a flow diagram illustrating an example of a method for merging a first concept and a second concept according to the disclosed subject matter.

FIG. 14 is a diagram illustrating an example of the user device and the information retrieval platform in which the personalized selection of applications for presentation on the web-based interface is produced according to the disclosed subject matter.

FIG. 15 is a diagram illustrating examples of records in an implementation of a personalized selection of applications cross reference database of the digital distribution platform according to the disclosed subject matter.

FIG. 16 is a block diagram illustrating an example of a system for producing a personalized selection of applications for presentation on a web-based interface according to the disclosed subject matter.

FIG. 17 illustrates an example computing device suitable for implementing aspects of the presently disclosed subject matter.

### DETAILED DESCRIPTION

As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

An information retrieval platform can be an electronic system configured to receive, from a user, a request that represents one or more characteristics of an informational need of the user. The information retrieval platform can be configured to produce a web-based interface to be transmitted to a user device of the user to facilitate receipt of the request. The web-based interface can be presented on the user device and can include a text box into which the user can enter the request as a query. The information retrieval platform can be configured to provide a response to the query. The response can include one or more data objects, from a collection of data objects, relevant to the informational need. A data object can be a particular way of organizing data so that the data can be used efficiently. Determining that a data object is relevant to the informational need can involve interpreting a relationship between the data object and the informational need. Accordingly, the information retrieval platform typically can perform operations to measure a degree of the relationship, or the relevancy, between the data object and the informational need. The response can be presented on the web-based interface as graphical control elements (e.g., icons) associated with the one or more data objects. Frequently, the response can include a large number of data objects. (For example, the Word Wide Web has over 4.7 billion pages and Google Play™ has over two million applications.) For at least this reason, the information retrieval platform usually can rank the data objects according to degrees of relevancy and can present the data objects according to their ranks.

The information retrieval platform can be configured to generate a cluster of data objects. A cluster can be a set of data objects grouped in such a way that data objects in the same cluster are more similar (in some sense or another) to each other than to data objects in other clusters. The response to the query can be presented on the web-based interface as data objects organized into clusters. The information retrieval platform can be configured to operate in conjunction with a digital distribution platform so that the data objects are for applications. The web-based interface can be used as a home page for the digital distribution platform. The home page can include a predetermined set of applications organized into predetermined clusters.

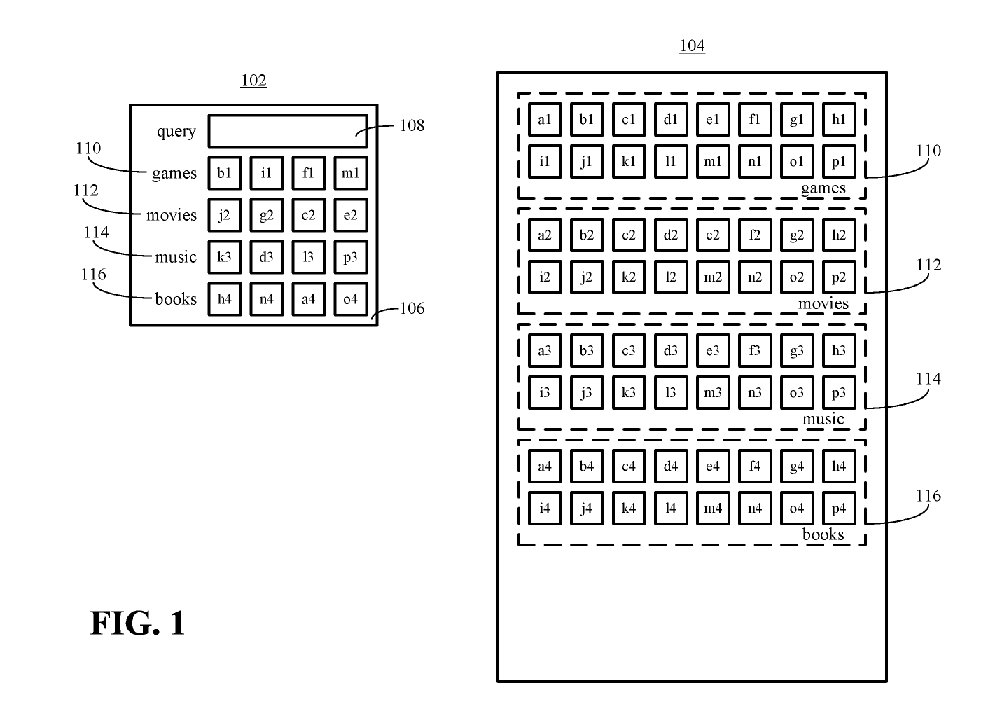

FIG. 1 is a diagram illustrating an example of a user device 102 and an information retrieval platform 104 in which a web-based interface 106 is used as a home page for a digital distribution platform. The user device 102 can be configured to present the web-based interface 106. The web-based interface 106 can include a text box 108 into which a user can enter a query. The information retrieval platform 104 can be configured to operate in conjunction with the digital distribution platform (not illustrated). The information retrieval platform 104 can be configured to generate a cluster of applications. For example, the information retrieval platform 104 can generate a “games” cluster 110, a “movies” cluster 112, a “music” cluster 114, and a “books” cluster 116. The “games” cluster 110 can include, for example, applications “a1” through “p1” each of which is related to games. The “movies” cluster 112 can include, for example, applications “a2” through “p2” each of which is related to movies. The “music” cluster 114 can include, for example, applications “a3” through “p3” each of which is related to music. The “books” cluster 116 can include, for example, applications “a4” through “p4” each of which is related to books.

The web-based interface 106 can be used as the home page for the digital distribution platform. The home page can include a predetermined set of applications organized into predetermined clusters. For example, the web-based interface 106 can present graphical control elements (e.g., icons) associated with some of the applications in the “games” cluster 110, the “movies” cluster 112, the “music” cluster 114, and the “books” cluster 116 that were predetermined to be included in the home page. The information retrieval platform 104 can rank the applications, presented on the web-based interface 106, according to pre-determined degrees of relevancy. For example, the web-based interface 106 can present applications “b1”, “i1”, “f1”, and “m1” from the “games” cluster 110, applications “j2”, “g2”, “c2”, and “e2” from the “movies” cluster 112, applications “k3”, “d3”, “l3”, and “p3” from the “music” cluster 114, and applications “h4”, “n4”, “a4”, and “o4” from the “books” cluster 116.

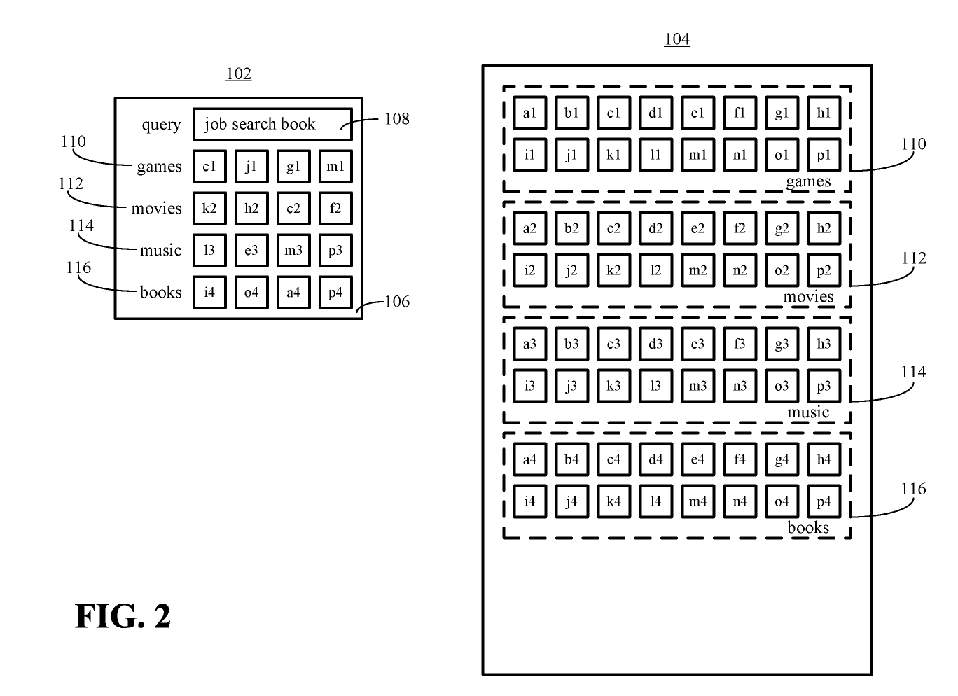

FIG. 2 is a diagram illustrating an example of the user device 102 and the information retrieval platform 104 in which the web-based interface 106 is used to facilitate a query. The information retrieval platform 104 can be configured to provide a response to the query entered into the text box 108 of the web-based interface 106. The response can include one or more applications relevant to an informational need represented by the query. The response can be presented on the web-based interface 106 as applications organized into clusters and ranked according to degrees of relevancy. For example, the web-based interface 106 can present graphical control elements (e.g., icons) associated with some of the applications in the “games” cluster 110, the “movies” cluster 112, the “music” cluster 114, and the “books” cluster 116 that were provided in response to the query. The information retrieval platform 104 can rank the applications, presented on the web-based interface 106, according to pre-determined degrees of relevancy. For example, the web-based interface 106 can present applications “c1”, “j1”, “g1”, and “m1” from the “games” cluster 110, applications “k2”, “h2”, “c2”, and “f2” from the “movies” cluster 112, applications “13”, “e3”, “m3”, and “p3” from the “music” cluster 114, and applications “i4”, “o4”, “a4”, and “p4” from the “books” cluster 116.

However, because: (1) the digital distribution platform can include a large number of applications (for example, Google Play™ has over two million applications) and (2) only a limited number of applications can be presented on the web-based interface 106, determining that an application is relevant to the informational need based strictly on a measure of a degree of relevancy can have an unintended consequence of producing a response that includes applications having a small degree of variety from one another. Such a response can fail to fully capture an intent of the user who entered the query. For example, if: (1) the user entered a query for “job search book” and (2) “What Color Is Your Parachute?” is the job search book with largest degree of relevancy, then a response in which (with reference to the web-based interface 106 illustrated in FIG. 2) application “i4” is the 2016 edition of “What Color Is Your Parachute?”, application “o4” is the 1998 edition of “What Color Is Your Parachute?”, application “a4” is the 1984 edition of “What Color Is Your Parachute?”, and application “p4” is the 1970 edition of “What Color Is Your Parachute?” would likely fail to fully capture the intent of the user who entered the query to find a variety of books related to “job search”. Although this is an extreme example, it highlights the problem of producing a response to a query based strictly on a measure of a degree of relevancy between an application and an informational need represented by the query.

Additionally, because: (1) a query for “job search book” can indicate that the user is interested in the topic of “job search” and (2) the applications presented on the web-based interface 106 in response to the query (“e1”, “j1”, “g1”, “m1”, “k2”, “h2”, “c2”, “f2”, “l3”, “e3”, “m3”, “p3”, “i4”, “o4”, “a4”, and “p4” illustrated in FIG. 2) can be substantially different from the applications presented on the web-based interface 106 used as the home page for the digital distribution platform (“b1”, “i1”, “f1”, “m1”, “j2”, “g2”, “c2”, “e2”, “k3”, “d3”, “l3”, “p3”, “h4”, “n4”, “a4”, and “o4” illustrated in FIG. 1), the applications presented on the web-based interface 106 used as the home page for the digital distribution platform may be directed to topics that are very different from the topics that are of interest to the user.

In contrast, according to the disclosed subject matter, a personalized selection of applications can be produced, based on a history of one or more queries associated with a user account of a user, for presentation on a web-based interface. The disclosed production of the personalized selection of applications is rooted in information retrieval technology to overcome a problem specifically arising from: (1) producing a response to a query based strictly on a measure of a degree of relevancy between an application and an informational need represented by the query and (2) failing to include other techniques to determine topics that are of interest to the user. Advantageously, because the disclosed production of the personalized selection of applications can present applications directed to topics that are of interest to the user, the disclosed production of the personalized selection of applications can preclude, in some instances, a need for the user to enter a query. Such preclusion of a need to enter a query can free bandwidth between the user device 102 and the information retrieval platform 104 to convey information other than the query and a response to the query.

The disclosed production of the personalized selection of applications can be realized using a natural language process, a semantic-search process, a word embedding process, a formal concept analysis process, the like, or any combination thereof. A natural language process can refer to a technique to interact with a computer system using a natural human language. A semantic-search process can refer to a technique to improve an understanding of: (1) an intent of a user who enters a query, (2) a contextual meaning of a term as it appears in a searchable dataspace, (3) the like, or (4) any combination thereof. A word embedding process can refer to a set of language modeling and feature learning techniques in which one or more words are mapped from a vocabulary to vectors of real numbers in a low-dimensional space relative to a size of the vocabulary (i.e., a number of dimensions of the vectors can be less than a number of words included in the vocabulary). (For example, the Oxford English Dictionary has a vocabulary of more than 200,000 words.) Dimensions of the vector can represent various aspects of the particular one or more words. For example, the aspects can include: (1) a number of occurrences of the particular one or more words in documents in a collection of documents, (2) other words and their displacements from the particular one or more words in a context of a phrase, (3) the like, or (4) any combination of the foregoing. A formal analysis concept process can refer to a technique for deriving a concept hierarchy or formal ontology from a collection of data objects and their properties. A concept in a hierarchy can represent a set of data objects that share same values for a specific set of the properties.

According to the disclosed subject matter, a first vector, which can represent one or more first words from a first query associated with the user account of the user, can be produced through a word embedding process. The first query can be a free-form text query. A second vector can be obtained. For example, the second vector can be retrieved from a knowledge base. For example, the knowledge base can include the Knowledge Graph (developed and maintained by Google Inc. of Mountain View, Calif.). The Knowledge Graph is a knowledge base used to enhance search results of a search engine with semantic-search information. A first determination can be made that a measure of similarity between the first vector and the second vector is greater than a threshold. The second vector can represent one or more second words. A second query can be transmitted to a digital distribution platform in response to the first determination. The second query can include the one or more first words (from the first query) and the one or more second words (derived from the second vector). (A response to a query with two sets of one or more words can be more likely to include applications having a large degree of variety from one another than a response to a query with only one set of the two sets of one or more words.) A response to the second query can be received from the digital distribution platform. The response to the second query can include an identification of a first application available for distribution by the digital distribution platform. A second determination can be made of an existence of a relationship between the first application and a second application available for distribution by the digital distribution platform. For example, the relationship can be based on: (1) an action performed on a user device associated with the user account and that involves the first application and the second application, (2) a same topic associated with the first application and the second application, (3) the like, or (4) any combination thereof. A cluster of applications can be generated in response to the second determination. The cluster of applications can include the first application and the second application. (A cluster with two applications can have a greater degree of variety than a cluster with only one of the two applications.) The personalized selection of applications can be produced, based on information about the cluster of applications, for presentation on the web-based interface for the user account associated with the first query.

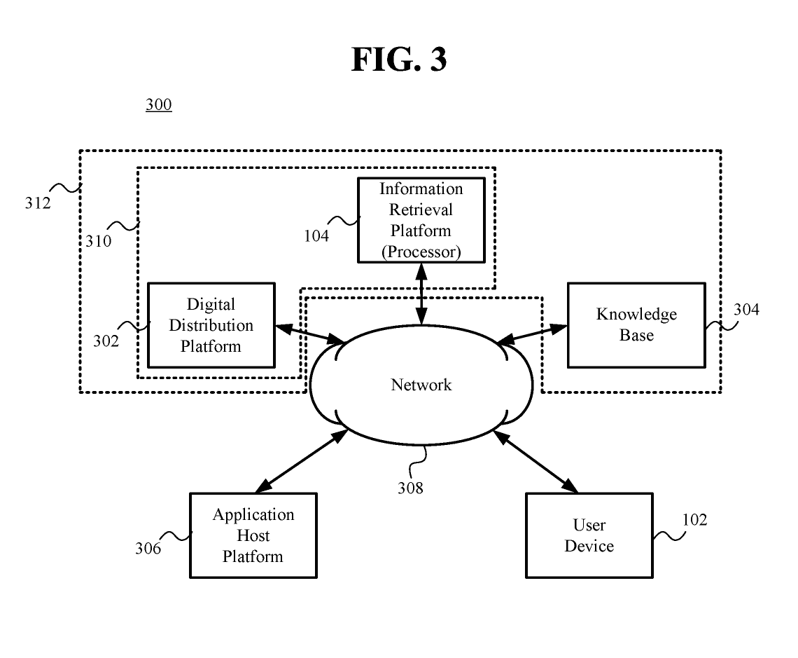

FIG. 3 is a diagram illustrating an example of a distributed computing system 300 in which the web-based interface, with a personalized selection of applications, can be produced according to the disclosed subject matter. The distributed computing system 300 can include several elements such as, for example, the user device 102, the information retrieval platform 104, a digital distribution platform 302, a knowledge base 304, and an application host platform 306. In an aspect, an element of the distributed computing system 300 can be communicatively connected to one or more other elements via a network 308.

In general, each of the information retrieval platform 104, the digital distribution platform 302, and the application host platform 306 can be a computer-implemented platform configured to automatically perform some or all of the functions disclosed herein. The information retrieval platform 104 can be, for example, a combination of hardware architecture, operating system, runtime libraries, and/or computer software or code object to support an information retrieval system. In an implementation, the information retrieval platform 104 can be configured specifically to support information retrieval operations. The digital distribution platform 302 can be, for example, a combination of hardware architecture, operating system, runtime libraries, and/or computer software or code object to support a digital distribution system. In an implementation, the digital distribution platform 302 can be configured specifically to support digital distribution operations. The application host platform 306 can be, for example, a combination of hardware architecture, operating system, runtime libraries, and/or computer software or code object to support an application host system. In an implementation, the application host platform 306 can be configured specifically to support application host operations. Alternatively, the information retrieval platform 104 and the digital distribution platform 302 can be combined in a platform 310. Alternatively, the information retrieval platform 104, the digital distribution platform 302, and the knowledge base 304 can be combined in a platform 312.

In general, the user device 102 can be, for example, any suitable electronic client device, such as a smartphone, a cellular phone, a personal digital assistant (PDA), a wireless communication device, a handheld device, a desktop computer, a laptop computer, a netbook, a tablet computer, a web portal, a digital video recorder, a video game console, an e-book reader, etc. The user device 102 can be associated with one or more users. Likewise, the user device 102 can be a plurality of user devices and a single user can be associated with one or more of the plurality of user devices.

The network 308 can be, for example, a telecommunications network configured to allow computers to exchange data. Connections between elements of the distributed computing system 300 via the network 308 can be established using cable media, wireless media, or both. Data traffic on the network 308 can be organized according to a variety of communications protocols including, but not limited to, the Internet Protocol Suite (Transmission Control Protocol/Internet Protocol (TCP/IP)), the Institute of Electrical and Electronics Engineers (IEEE) 802 protocol suite, the synchronous optical networking (SONET) protocol, the Asynchronous Transfer Mode (ATM) switching technique, the like, or any combination thereof. In an aspect, the network 308 can include the Internet.

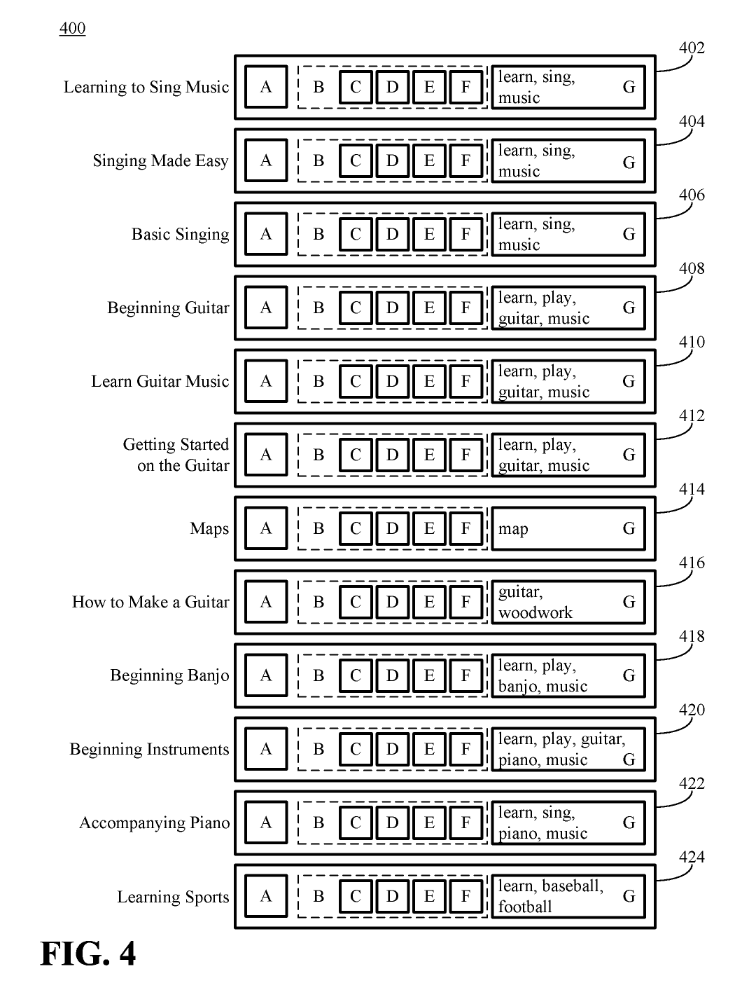

FIG. 4 is a diagram illustrating examples of data objects for applications, of a collection of data objects 400, in an implementation of the digital distribution platform 302. Each data object can be associated with a corresponding application. For example, each of the data objects can include a graphical representation A, web-interface position metadata B, and an attribute field G (e.g., keywords). The graphical representation A can be, for example, a picture (or another type of illustration) to be used for an icon (or another graphical control element) for the corresponding application on the web-based interface 106. The web-interface position metadata B can be used, for example, to determine a rank of the corresponding application associated with the data object and to determine a position of the icon (or the other graphical control element) on the web-based interface 106. The web-interface position metadata B can include, for example, a popularity field C, a revenue field D, an evaluation score field E, and a user activity field F. The popularity field C can include a value for a measure of a popularity of the corresponding application with respect to other applications available for distribution by the digital distribution platform 302. The revenue field D can include a value for a measure of a number of sales of the corresponding application. This value can represent total sales of the corresponding application, sales of the corresponding application as a percentage of sales of a group of applications, or the like. The evaluation score field E can include a value that represents an aggregate score of evaluations of the corresponding application. These evaluations can be performed by users of the corresponding application, developers of applications, critics, the like, or any combination thereof. The user activity field F can include a value for a measure of activities involving the corresponding application. These activities can include downloads, opens, updates, deletions, the like, or any combination thereof. Alternatively, the web-interface position metadata B can include fewer fields, additional fields, or different fields. The attribute field G (e.g., keywords) can include, for example, one or more words that can be used by the information retrieval platform 104 as a basis for determining a degree of relevancy between the corresponding application and an informational need represented by a query.

The collection of data objects 400 can include, for descriptive purposes herein, a data object 402 for the application Learning to Sing Music, a data object 404 for the application Singing Made Easy, a data object 406 for the application Basic Singing, a data object 408 for the application Beginning Guitar, a data object 410 for the application Learn Guitar Music, a data object 412 for the application Getting Started on the Guitar, a data object 414 for the application Maps, a data object 416 for the application How to Make a Guitar, a data object 418 for the application Beginning Banjo, a data object 420 for the data object Beginning

Instruments, a data object 422 for the application Accompanying Plano, and a data object 424 for the application Learning Sports.

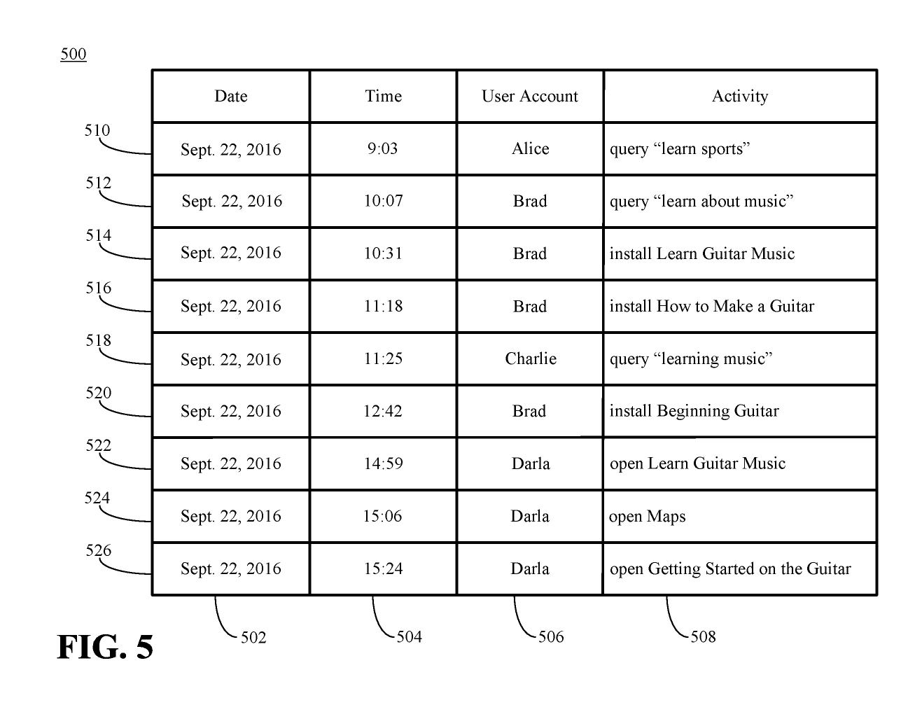

FIG. 5 is a diagram illustrating examples of records in an implementation of an activity log database 500 of the digital distribution platform 302. For example, each of the records can include a field 502 for a date of an activity, a field 504 for a time of the activity, a field 506 for an identification of a user account associated with the activity, and a field 508 for a description of the activity. The activity log database 500 can include, for descriptive purposes herein, a record 510 for an instance of receiving a query for “learn sports” associated with a user account for Alice, a record 512 for an instance of receiving a query for “learn about music” associated with a user account for Brad, a record 514 for an instance of installing the application Learn Guitar Music associated with the user account for Brad, a record 516 for an instance of installing the application How to Make a Guitar associated with the user account for Brad, a record 518 for an instance of receiving a query for “learning music” associated with a user account for Charlie, a record 520 for an instance of installing the application Beginning Guitar associated with the user account for Brad, a record 522 for an instance of opening the application Learn Guitar Music associated with a user account for Darla, a record 524 for an instance of opening the application Maps associated with the user account for Darla, and a record 526 for an instance of opening the application Getting Started on the Guitar associated with the user account for Darla.

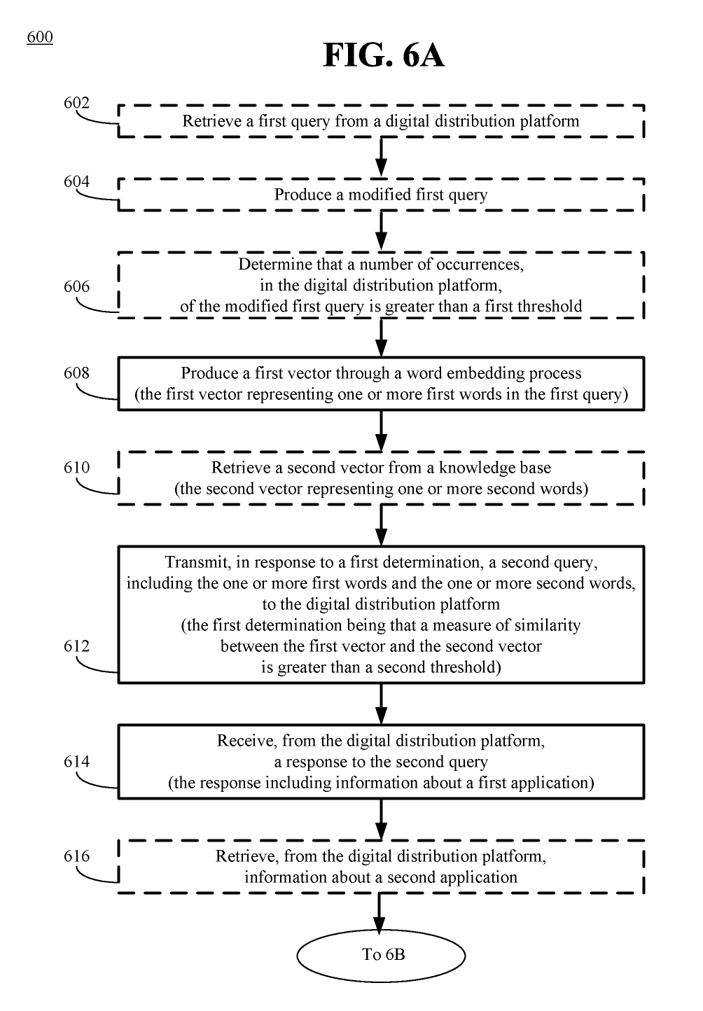

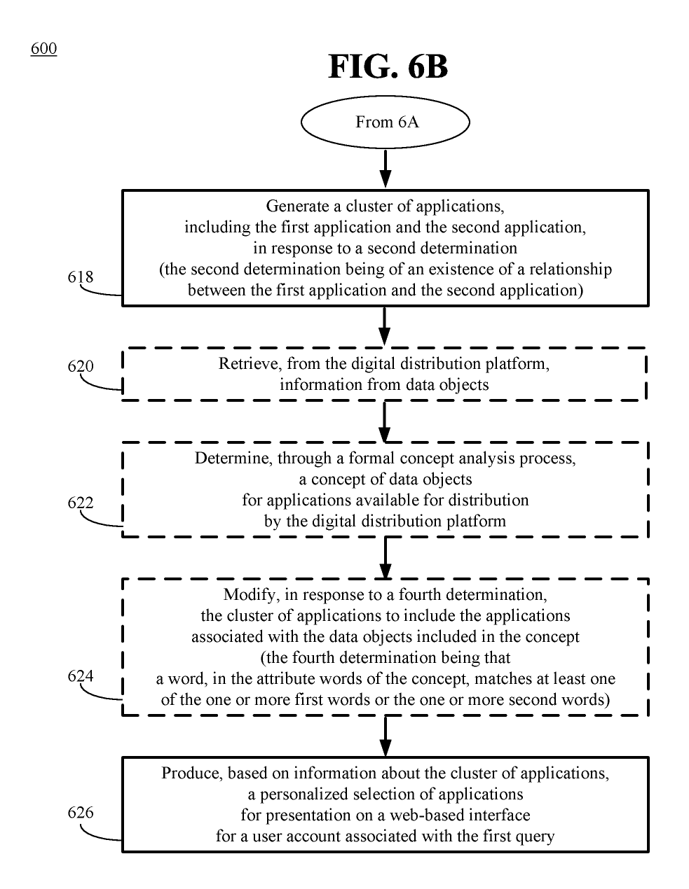

FIGS. 6A and 6B are a flow diagram illustrating an example of a method 600 for producing the personalized selection of applications for presentation on the web-based interface according to the disclosed subject matter. In the method 600, at an optional operation 602, a first query can be retrieved, by a processor, from a digital distribution platform. The processor can be, for example, a processor of an information retrieval platform (e.g., the information retrieval platform 104). The digital distribution platform can be, for example, the digital distribution platform 302. For example, with reference to FIG. 5 and for descriptive purposes herein, the first query can be the query for “learn about music” from the record 512. The first query can be a free-form text query. The first query can include one or more first words. For example, the one or more first words can be “learn”, “about”, and “music”.

Returning to FIG. 6A, at an optional operation 604, a modified first query can be produced by the processor. The modified first query can be produced, for example, by: (1) changing a specific tense of a first specific word of the one or more first words (e.g., changing from “learning” to “learn”), (2) changing a specific grammatical number of a second specific word of the one or more first words (e.g., changing from “people” to “person”), (3) removing a stop word from the first query, (4) the like, or (5) any combination thereof. The stop word can be a word that can be removed, in conjunction with a natural language process, from a first collection of words to produce a second collection of words. The stop word can be a common word in a language. For example, the stop word can be a short function word such as “the,” “is,” “at,” “which,” “on,” “about,” or the like. The stop word can be included, for example, on a stop list. A request for information, from an information retrieval system, that uses the second collection of words can provide a response with information that is more relevant to an intent of the request than a request for information that uses the first collection of words. For example, with reference to FIG. 5 and for descriptive purposes herein, the modified first query can be “learn music” in which the stop word “about” was removed from the first query.

Returning to FIG. 6A, at an optional operation 606, the processor can determine that a number of occurrences, in the digital distribution platform, of the modified first query is greater than a first threshold. For example, the first threshold can be one. For example, with reference to FIG. 5 and for descriptive purposes herein, the processor can determine that the modified first query, “learn music”, occurs two times in the digital distribution platform (e.g., first, in the record 512 in which the stop word “about” was removed from the query “learn about music”, and second, in the record 518 in which the tense of “learning” was changed to “learn” in the query “learning music”). The processor can determine that two is greater than one (e.g., the first threshold). In this manner, the method 600 can determine that the modified first query “learn music” is a relatively popular modified query.

Returning to FIG. 6A, at an operation 608, a first vector can be produced, by the processor, through a word embedding process. The first vector can represent the one or more first words. The word embedding process can include, for example: (1) a neural network process, (2) a process to reduce dimensions of a word co-occurrence matrix, (2) a process that uses a probabilistic model, (4) a process to represent the one or more first words in terms of a context in which the one or more first words are used, (5) the like, or (6) any combination thereof. A dimension of the first vector can include, for example: (1) a number of occurrences of the one or more first words in documents in a collection of documents, (2) another word and a displacement of the other word from one of the one or more first words in a context of a phrase, (3) the like, or (4) any combination thereof.

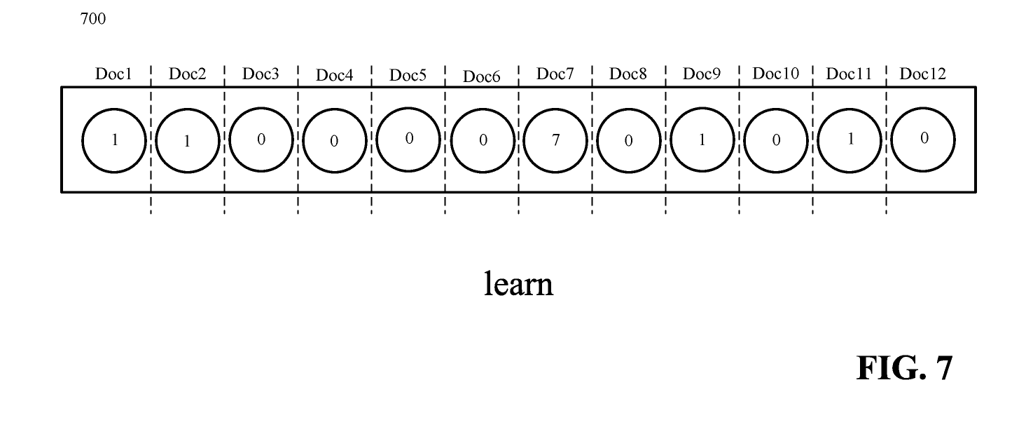

FIG. 7 is a diagram illustrating an example of a vector 700, produced through a word embedding process, in which dimensions can represent a number of occurrences of a particular word in documents in a collection of documents. The vector 700 can be referred to as a document occurrence vector. For example, as illustrated in FIG. 7 for descriptive purposes herein, the particular word can be “learn”, the collection of documents can include twelve documents, and the vector 700 can have twelve dimensions. Each dimension of the vector 700 can be associated with a corresponding document. The value for a dimension of the vector 700 can be a number of occurrences of the particular word in the corresponding document. For example, in the vector 700, the value for each of dimensions “Doc3”, “Doc4”, “Doc5”, “Doc6”, “Doc8”, “Doc10”, and “Doc12” is zero; the value for each of dimensions “Doc1”, “Doc2”, “Doc9”, and “Doc11” is one; and the value for the dimension “Doc7” is seven.

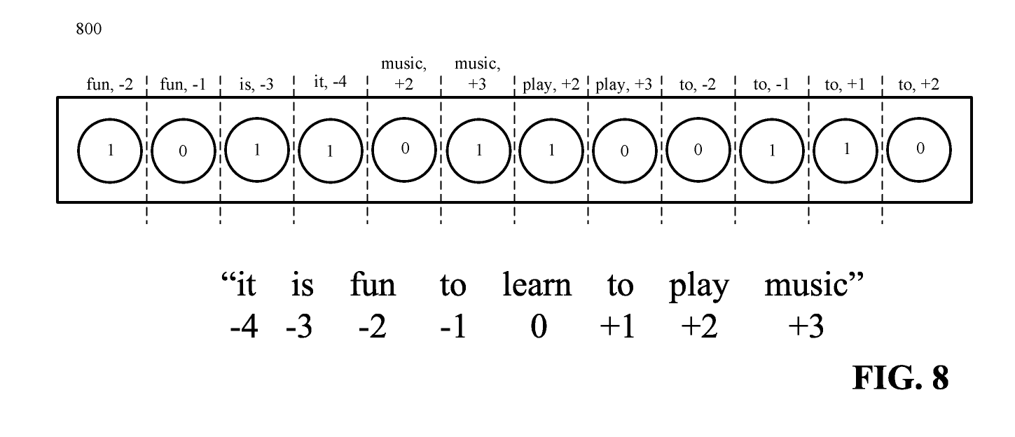

FIG. 8 is a diagram illustrating an example of a vector 800, produced through a word embedding process, in which dimensions can represent other words and their displacement from a particular word in a context of a phrase. The vector 800 can be referred to as a word context vector. For example, as illustrated in FIG. 8 for descriptive purposes herein, the particular word can be “learn”, the phrase can be “it is fun to learn to play music”, and the vector 800 can have twelve dimensions. In the phrase “it is fun to learn to play music”, the word “it” can be displaced four words before the particular word “learn” (−4), the word “is” can be displaced three words before the particular word “learn” (−3), the word “fun” can be displaced two words before the particular word “learn”, the word “to” can be displaced both: (1) one word before the particular word “learn” (−1) and (2) one word after the particular word “learn” (+1), the word “play” can be displaced two words after the particular word “learn”, and the word “music” can be displaced three words after the particular word “learn”.

Therefore, in the vector 800, the value for the dimension “fun, −2” can be one, the value for the dimension “fun, −1” can be zero, the value for the dimension “is, −3” can be one, the value for the dimension “it, −4” can be one, the value for the dimension “music, +2” can be zero, the value for the dimension “music, +3” can be one, the value for the dimension “play, +2” can be one, the value for the dimension “play, +3” can be zero, the value for the dimension “to, −2” can be zero, the value for the dimension “to, −1” can be one, the value for the dimension “to, +1” can be one, and the value for the dimension “to, +2” can be zero.

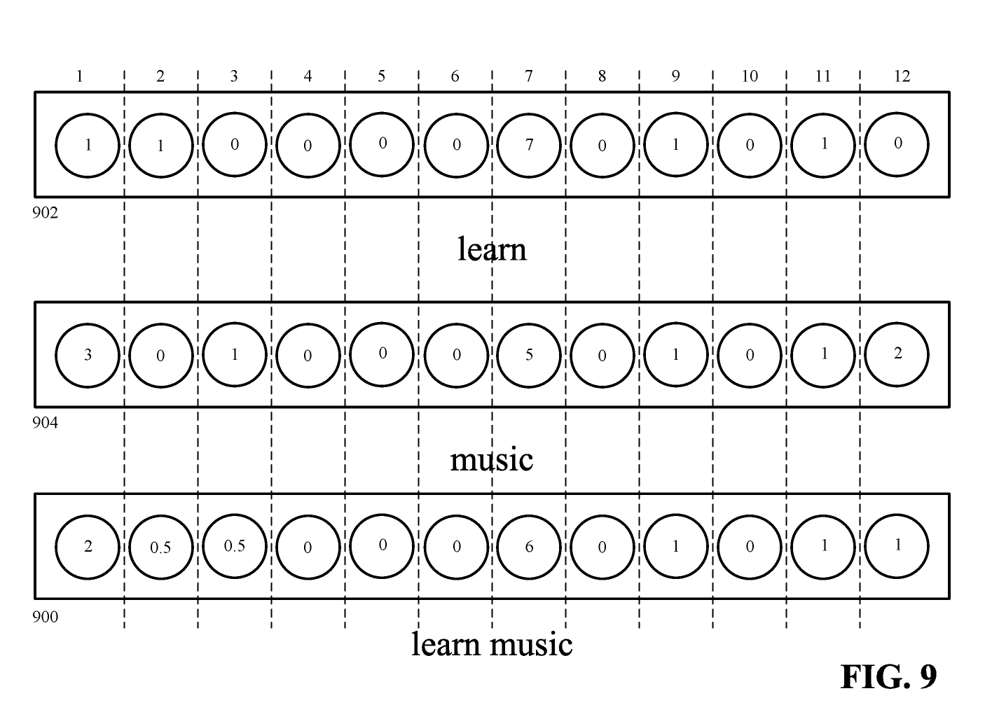

FIG. 9 is a diagram illustrating an example of a vector 900, produced through a word embedding process, which can be an aggregate of vectors for words included in the one or more first words. For example, as illustrated in FIG. 9 for descriptive purposes herein, the vector 900 for “learn music” can be an aggregate of the vector 902 for “learn” and the vector 904 for “music”. The aggregate can be, for example, a dimension by dimension aggregation. The aggregate can be, for example, an average. For example, in the vector 900, the value of the first dimension can be 2, an average of 1 and 3; the value of the second dimension can be 0.5, an average of 1 and 0; the value of the third dimension can be 0.5, an average of 0 and 1; the value of the fourth dimension can be 0, an average of 0 and 0; the value of the fifth dimension can be 0, an average of 0 and 0; the value of the sixth dimension can be 0, an average of 0 and 0; the value of the seventh dimension can be 6, an average of 7 and 5; the value of the eighth dimension can be 0, an average of 0 and 0; the value of the ninth dimension can be 1, an average of 1 and 1; the value of the tenth dimension can be 0, an average of 0 and 0; the value of the eleventh dimension can be 1, an average of 1 and 1; and the value of the twelfth dimension can be 1, an average of 0 and 2.

One of skill in the art in light of the description herein understands other dimensions that can be used for the first vector besides the dimensions illustrated in FIGS. 7 through 9.

Returning to FIG. 6A, at an optional operation 610, the processor can retrieve, from a knowledge base, a second vector. The second vector can represent one or more second words. For example, the one or more second words can be “play”, “guitar”, or both. For example, a knowledge base can be a technology used to store complex structured and unstructured information used by a computer system. The knowledge base can include, for example, the Knowledge Graph (developed and maintained by Google Inc. of Mountain View, Calif.).

At an operation 612, a second query can be transmitted, from the processor to the digital distribution platform, in response to a first determination. The second query can include the one or more first words (from the first query) and the one or more second words (derived from the second vector). (A response to a query with two sets of one or more words can be more likely to include applications having a large degree of variety from one another than a response to a query with only one set of the two sets of one or more words.) For, example, the second query can include “learn” and “music” (from the first query) and “play” and “guitar” (derived from the second vector).

The first determination can be that a measure of similarity between the first vector and a second vector is greater than a second threshold. The measure of similarity can include, for example: (1) a cosine similarity between the first vector and the second vector, (2) a product of the first vector multiplied by a weight, (3) the like, or (4) any combination thereof. A value of the weight can be determined, for example, by: (1) a part of speech of one of the one or more the first words (e.g., noun, pronoun, adjective, verb, adverb, preposition, conjunction, or interjection), (2) a number of occurrences of the first word in documents in a collection of documents, (3) the like, or (4) any combination thereof.

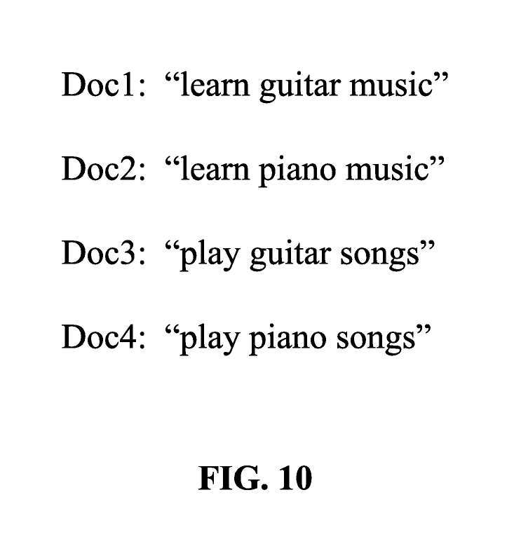

FIG. 10 is a diagram illustrating an example of some documents in the collection of documents referenced in the description of FIG. 7. For example, as illustrated in FIG. 10 for descriptive purposes herein, “Doc1” can be a document that states “learn guitar music”, “Doc2” can be a document that states “learn plano music”, “Doc3” can be a document that states “play guitar songs”, and “Doc4” can be a document that states “play plano songs”.

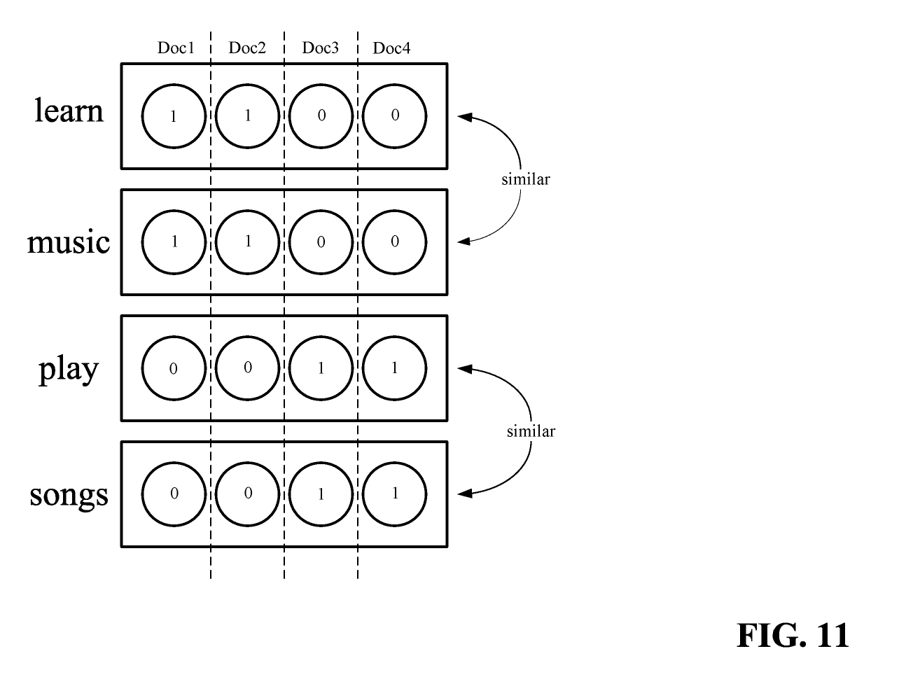

FIG. 11 is a diagram illustrating an example of a determination of similarity between document occurrence vectors. With reference to FIGS. 10 and 11 and for descriptive purposes herein, for the “learn” vector, the value for each of dimensions “Doc1” and “Doc2” is one, and the value for each of dimensions “Doc3” and “Doc4” is zero; for the “music” vector, the value for each of dimensions “Doc1” and “Doc2” is one, and the value for each of dimensions “Doc3” and “Doc4” is zero; for the “play” vector, the value for each of dimensions “Doc1” and “Doc2” is zero, and the value for each of dimensions “Doc3” and “Doc4” is one; and for the “songs” vector, the value for each of dimensions “Doc1” and “Doc2” is zero, and the value for each of dimensions “Doc3” and “Doc4” is one. From this, a determination can be made that the document “Doc1” (“learn guitar music”) can be similar to the document “Doc2” (“learn plano music”); and a determination can be made that the document “Doc3” (“play guitar songs”) can be similar to the document “Doc4” (“play plano songs”).

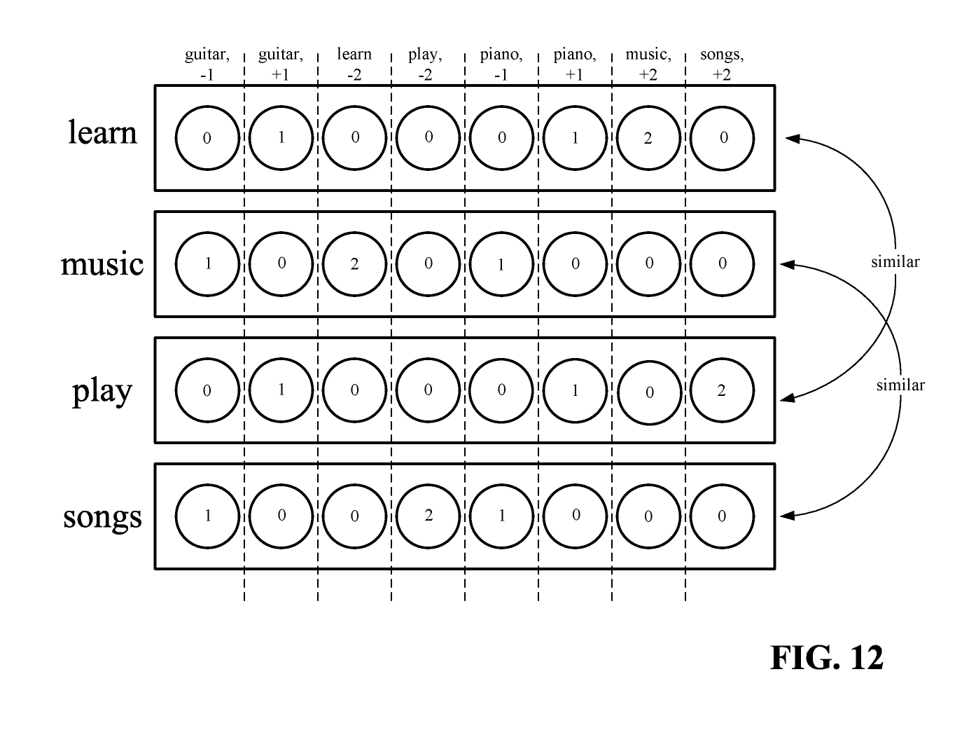

FIG. 12 is a diagram illustrating an example of a determination of similarity between word context vectors. With reference to FIGS. 10 and 12 and for descriptive purposes herein, for the “learn” vector, the value for each of dimensions “guitar, −1”, “learn, −2”, “play, −2”, “plano, −1”, and “songs, +2” is zero, the value for each of dimensions “guitar, +1” and “plano, +1” is one, and the value for the dimension “music, +2” is two; for the “music” vector, the value for each of dimensions “guitar, +1”, “play, −2”, “plano, +1”, “music, +2”, and “songs, +2” is zero, the value for each of dimensions “guitar, −1” and “plano, −1” is one, and the value for the dimension “learn, −2” is two; for the “play” vector, the value for each of dimensions “guitar, −1”, “learn, −2”, “play, −2”, “plano, −1”, and “music, −2” is zero, the value for each of dimensions “guitar, +1” and “plano, +1” is one, and the value for the dimension “songs, +2” is two; and for the “songs” vector, the value for each of dimensions “guitar, +1”, “learn, −2”, “plano, +1”, “music, +2”, and “songs, +2” is zero, the value for each of dimensions “guitar, −1” and “plano, −1” is one, and the value for dimension “play, −2” is two. From this, a determination can be made that “learn” can be similar to “play”; and a determination can be made that “music” can be similar to “songs”.

One of skill in the art in light of the description herein understands other techniques that can be used to make a determination of similarity between vectors besides the techniques illustrated in FIGS. 11 and 12.

Returning to FIG. 6A, at an operation 614, a response to the second query can be received, from the digital distribution platform, by the processor. The response to the second query can include an identification of a first application. The first application can be available for distribution by the digital distribution platform. For example, the first application can be Learn Guitar Music.

At an optional operation 616, information about a second application can be retrieved, by the processor, from the digital distribution platform. The second application can be available for distribution by the digital distribution platform. For example, the information about the second application can be used by the processor to perform the operation 618 illustrated in FIG. 6B.

In FIG. 6B, at the operation 618, a cluster of applications can be generated by the processor in response to a second determination. The cluster of applications can include the first application and the second application. The second determination can be of an existence of a relationship between the first application and the second application. The existence of the relationship can include, for example: (1) an indication that the first application was opened on a user device, associated with a user account associated with the first query, at a first time, and the second application was opened on the user device at a second time; (2) an indication that the first application was installed on the user device at a third time, and the second application was installed on the user device at a fourth time; (3) an indication that the first application and the second application are related to a same topic; (4) the like; or (5) any combination thereof. Optionally, the first time can be different from the second time, and the first time and the second time can be within a first duration of time. Optionally, the third time can be different from the fourth time, and the third time and the fourth time can be within a second duration of time.

For example, with reference to FIG. 5 and for descriptive purposes herein, if the first application is Learn Guitar Music and the first duration of time is fifteen minutes, then because: (1) the application Learn Guitar Music was opened on a user device associated with a user account for Darla at 14:59 on Sep. 22, 2016 (and assuming that the first query was entered by the user account for Darla), (2) the application Maps was opened on the user device at 15:06 on Sep. 22, 2016, and (3) the duration of time between 14:59 and 15:06 is less than fifteen minutes, a relationship can exist between the application Learn Guitar Music and the application Maps. Therefore, the application Maps can be included in the cluster of applications (for Darla) with the application Learn Guitar Music.

For example, with reference to FIG. 5 and for descriptive purposes herein, if the first application is Learn Guitar Music and the second duration of time is one hour, then because: (1) the application Learn Guitar Music was installed on a user device associated with a user account for Brad at 10:31 on Sep. 22, 2016, (2) the application How to Make a Guitar was installed on the user device at 11:18 on Sep. 22, 2016, and (3) the duration of time between 14:59 and 11:18 is less than one hour, a relationship can exist between the application Learn Guitar Music and the application How to Make a Guitar. Therefore, the application How to Make a Guitar can be included in the cluster of applications (for Brad) with the application Learn Guitar Music.

For example, with reference to FIG. 5 and for descriptive purposes herein, if the first application is Learn Guitar Music, then because the application Learn Guitar Music and the application Getting Started on the Guitar are related to a same topic, a relationship can exist between the application Learn Guitar Music and the application Getting Started on the Guitar. Therefore, the application Getting Started on the Guitar can be included in the cluster of applications for any user account in which the cluster of applications includes Learn Guitar Music.

For example, with reference to FIG. 5 and for descriptive purposes herein, note that because: (1) the application Learn Guitar Music was opened on the user device associated with the user account for Darla at 14:59 on Sep. 22, 2016 (and assuming that the first query was entered by the user account for Darla), (2) the application Getting Started on the Guitar was opened on the user device at 15:24 on Sep. 22, 2016, and (3) the duration of time between 14:59 and 15:24 is greater than fifteen minutes, the relationship (for Darla) between the application Learn Guitar Music and the application Getting Started on the Guitar may not be based on a difference in time between when the two applications are opened.

Therefore, the cluster of applications for Darla can include the application Learn Guitar Music, the application Maps, and the application Getting Started on the Guitar; the cluster of applications for Brad can include the application Learn Guitar Music, the application How to Make a Guitar, and the application Getting Started on the Guitar.

Returning to FIG. 6B, at an optional operation 620, information from data objects can be retrieved, by the processor, from the digital distribution platform. For example, the information from the data objects can be used by the processor to perform the operation 622 illustrated in FIG. 6B.

At the optional operation 622, a concept of data objects for applications available for distribution by the digital distribution platform (i.e., a concept) can be determined, by the processor, through a formal concept analysis process. The concept can include a set of data objects from a population of data objects. The set of data objects can be defined by a set of specific words included in an attribute field of each data object in the set of data objects.

For example, with reference to FIG. 4 and for descriptive purposes herein, if the set of specific words included in the attribute field G (e.g., keywords) is the set of words “learn” and “music”, then the concept can include the data objects for the application Learning to Sing Music, the application Singing Made Easy, the application Basic Singing, the application Beginning Guitar, the application Learn Guitar Music, the application Getting Started on the Guitar, the application Beginning Instruments, and the application Accompanying Plano.

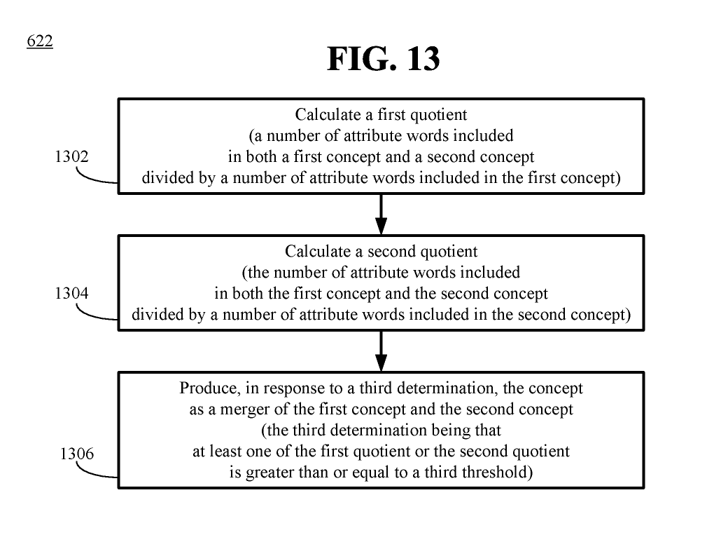

Optionally, the concept can include a merger of a first concept and a second concept. (For example, several concepts may be determined though performance of the operation 622.) The merger can be produced by merging the first concept and the second concept. FIG. 13 is a flow diagram illustrating an example of a method 622 for merging a first concept and a second concept according to the disclosed subject matter. In the method 622, at an operation 1302, a first quotient can be calculated. The first quotient can be a number of words included in a set of specific words included in an attribute field of each data object included in both the first concept and the second concept divided by a number of words included in a set of specific words included in the attribute field of the each data object included in the first concept.

For example, with reference to FIG. 4 and for descriptive purposes herein, if: (1) the set of specific words included in the attribute field G (e.g., keywords) is the set of words “learn”, “music”, and “sing” (e.g., the first concept includes the data objects for the application Learning to Sing Music, the application Singing Made Easy, the application Basic Singing, and the application Accompanying Plano) (i.e., three words), (2) the set of specific words included in the attribute field G (e.g., keywords) is the set of words “learn”, “music”, “play”, and “guitar” (e.g., the second concept includes the data objects for the application the application Beginning Guitar, the application Learn Guitar Music, the application Getting Started on the Guitar, and the application Beginning Instruments), (3) the set of specific words included in the attribute field G (e.g., keywords) is the set of words “learn” and “music” (e.g., the words included in the set of specific words included in the attribute field G (e.g., keywords) of each data object included in both the first concept and the second concept) (i.e., two words), then the first quotient can be 2/3.

Returning to FIG. 13, at an operation 1304, a second quotient can be calculated. The second quotient can be the number of words included in the set of specific words included in the attribute field of the each data object included in both the first concept and the second concept divided by a number of words included in a set of specific words included in the attribute field of the each data object included in the second concept.

For example, with reference to FIG. 4 and for descriptive purposes herein, if: (1) the set of specific words included in the attribute field G (e.g., keywords) is the set of words “learn”, “music”, “play”, and “guitar” (e.g., the second concept includes the data objects for the application the application Beginning Guitar, the application Learn Guitar Music, the application Getting Started on the Guitar, and the application Beginning Instruments) (i.e., four words), (2) the set of specific words included in the attribute field G (e.g., keywords) is the set of words “learn”, “music”, and “sing” (e.g., the first concept includes the data objects for the application Learning to Sing Music, the application Singing Made Easy, the application Basic Singing, and the application Accompanying Plano), (3) the set of specific words included in the attribute field G (e.g., keywords) is the set of words “learn” and “music” (e.g., the words included in the set of specific words included in the attribute field G (e.g., keywords) of each data object included in both the first concept and the second concept) (i.e., two words), then the second quotient can be 2/4.

Returning to FIG. 13, at an operation 1306, the merger can be produced in response to a third determination. The third determination can be that at least one of the first quotient or the second quotient is greater than or equal to a third threshold. For example, if the third threshold is 0.5, then each of the first quotient (2/3) and the second quotient (2/4) is greater than or equal to the third threshold (0.5). Therefore, the merger of the first concept and the second concept can be produced.

Returning to FIG. 6B, at an optional operation 624, the cluster of applications can be modified, by the processor and in response to a fourth determination, to include the applications associated with the data objects included in the concept. The fourth determination can be that a word, of the set of specific words, matches at least one of the one or more first words or the one or more second words.

For example, with reference to FIG. 4 and for descriptive purposes herein, if: (1) the set of specific words included in the attribute field G (e.g., keywords) is the set of words “learn” and “music” and (2) the first word is “learn” and the second word is “play” (alternatively or additionally, if the other first word is “music” and the one or more second words is “sing” and “guitar”), then a word of the set of specific words matches at least one of the first word or the second word and the cluster of applications can be modified to include the applications associated with the data objects included in the concept.

Therefore, the cluster of applications for Darla can include the application Learn Guitar Music, the application Maps, the application Getting Started on the Guitar, the application Learning to Sing Music, the application Singing Made Easy, the application Basic Singing, the application Beginning Guitar, the application Beginning Instruments, and the application Accompanying Plano; the cluster of applications for Brad can include the application Learn Guitar Music, the application How to Make a Guitar, the application Getting Started on the Guitar, the application Learning to Sing Music, the application Singing Made Easy, the application Basic Singing, the application Beginning Guitar, the application Getting Started on the Guitar, the application Beginning Instruments, and the application Accompanying Plano.

Returning to FIG. 6B, at an operation 626, the personalized selection of applications for presentation on the web-based interface for the user account associated with the first query can be produced by the processor based on information about the cluster of applications.

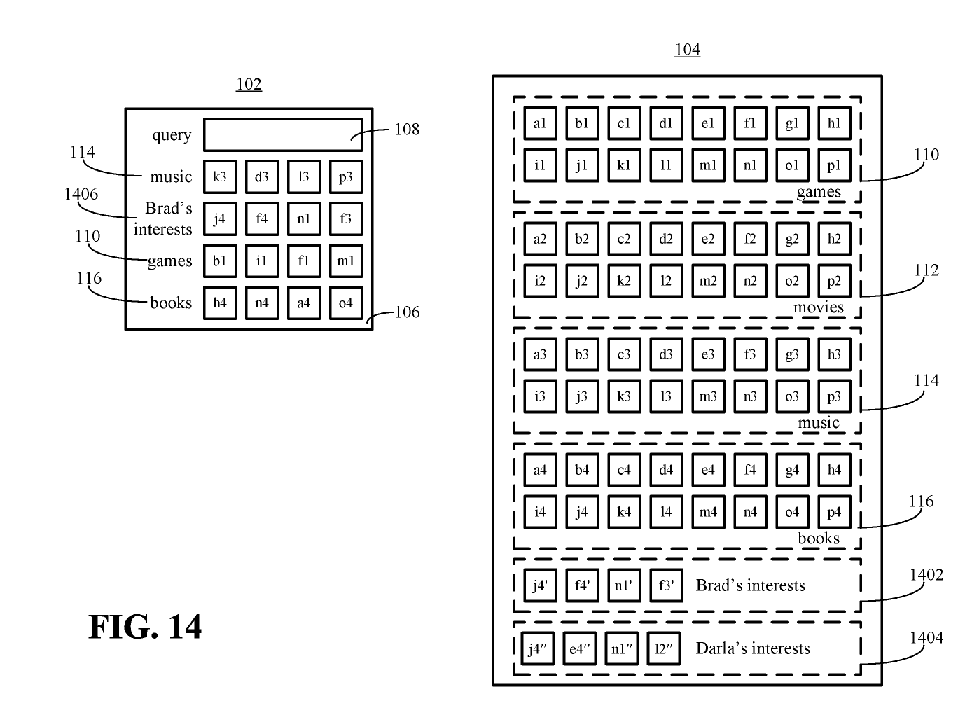

FIG. 14 is a diagram illustrating an example of the user device 102 and the information retrieval platform 104 in which the personalized selection of applications 1402 for presentation on the web-based interface 106 is produced according to the disclosed subject matter. The information retrieval platform 104 can be configured to generate the cluster of applications. For example, the information retrieval platform 104 can generate the “games” cluster 110, the “movies” cluster 112, the “music” cluster 114, and the “books” cluster 116. The “games” cluster 110 can include, for example, the applications “a1” through “p1” each of which is related to games. The “movies” cluster 112 can include, for example, the applications “a2” through “p2” each of which is related to movies. The “music” cluster 114 can include, for example, the applications “a3” through “p3” each of which is related to music. The “books” cluster 116 can include, for example, the applications “a4” through “p4” each of which is related to books.

Additionally, the information retrieval platform 104 can be configured to generate the cluster of applications for the user account associated with the first query. For example, the information retrieval platform 104 can generate the “Brad's interests” cluster 1402 (based on the first query having been entered by the user account associated with Brad) and the “Darla's interests” cluster 1404 (based on the first query having been entered by the used account associated with Darla). The “Brad's interests” cluster 1402 can include, for example, modified data objects associated with those applications, from the “games” cluster 110, the “movies” cluster 112, the “music” cluster 114, and the “books” cluster 116, determined to be related to the topics that are of interest to Brad. For example, the “Brad's interests” cluster 1402 can include a modified data object “j4”' (for the application Learn Guitar Music) from the “books” cluster 116, a modified data object “f4′” (for the application

How to Make a Guitar) from the “books” cluster 116, a modified data object “n1”' (for the application Getting Started on the Guitar) from the “games” cluster 110, and a modified data object “f3”' (for the application Learning to Sing Music) from the “music” cluster 114. Likewise, the “Darla's interests” 1404 can include, for example, modified data objects associated with those applications, from the “games” cluster 110, the “movies” cluster 112, the “music” cluster 114, and the “books” cluster 116, determined to be related to the topics that are of interest to Darla. For example, the “Darla's interests” cluster 1404 can include a modified data object “j4″” (for the application Learn Guitar Music) from the “books” cluster 116, a modified data object “c4″” (for the application Maps) from the “books” cluster 116, a modified data object “n1″” (for the application Getting Started on the Guitar) from the “games” cluster 110, and a modified data object “12″” (for the application Singing Made Easy) from the “movies” cluster 112.

The user device 102 illustrated in FIG. 14 can be associated with the user account for Brad. The user device 102 can be configured to present the personalized selection of applications 1406 (associated with the “Brad's interest” cluster 1402) on the web-based interface 106. The information retrieval platform 104 can rank the applications, presented on the web-based interface 106, according to a combination of pre-determined degrees of relevancy and information about the topics that are of interest to Brad. For example, the web-based interface 106 can present the applications “k3”, “d3”, “l3”, and “p3” from the “music” cluster 114, the applications “j4”, “f4”, “n1”, and “f3” from the “Brad's interests” cluster 1402, the applications “b1”, “i1”, “f1”, and “m1” from the “games” cluster 110, and the applications “h4”, “n4”, “a4”, and “o4” from the “books” cluster 116. In an aspect, the personalized selection of applications 1406 can include a sufficient number of applications that the personalized selection of applications 1406 can occupy substantially all of an area of the web-based interface 106. In an aspect, the method 600 can be performed in one or more iterations.

Because the applications presented on the web-based interface 106 can include the personalized selection of applications 1406, the applications presented on the web-based interface 106 may be directed to topics of interest to Brad. Because the applications presented on the web-based interface 106 may be directed to topics of interest to Brad, the web-based interface 106 with the personalized selection of applications 1406 can preclude, in some instances, a need for Brad to enter a query. Such preclusion of a need to enter a query can free bandwidth between the user device 102 and the information retrieval platform 104 to convey information other than the query and a response to the query.

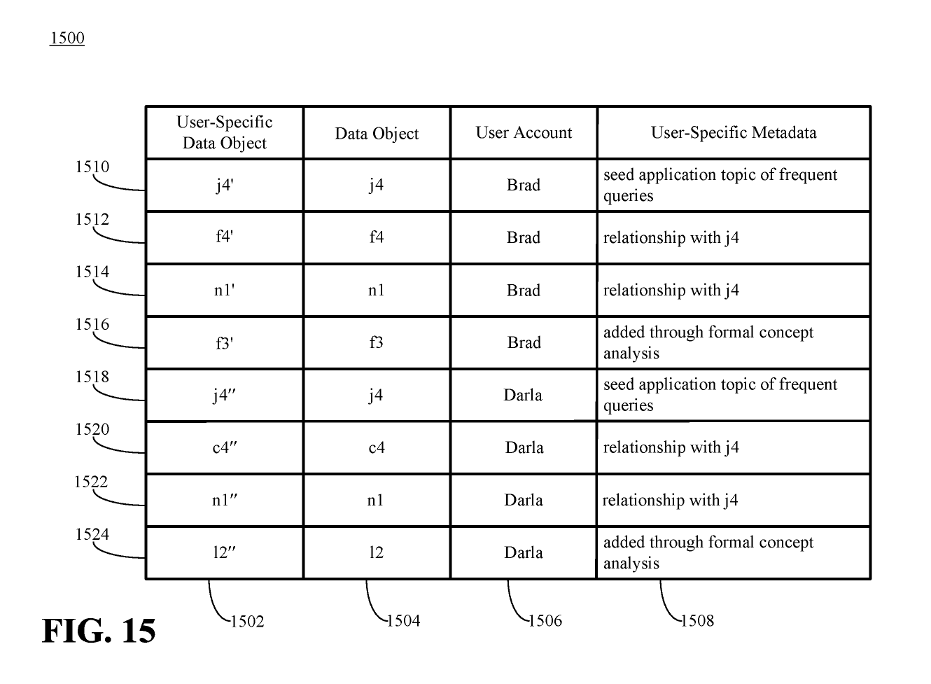

FIG. 15 is a diagram illustrating examples of records in an implementation of a personalized selection of applications cross reference database 1500 of the digital distribution platform 302 according to the disclosed subject matter. For example, each of the records can include a field 1502 for a user-specific data object, a field 1504 for a corresponding data object, a field 1506 for an identification of a user account related to the data object, and a field 1508 for user-specific metadata. The personalized selection of applications cross reference database 1500 can include, for descriptive purposes herein, a record 1510 for the data object “j4” related to the user account for Brad, a record 1512 for the data object “f4” related to the user account for Brad, a record 1514 for the data object “n1” related to the user account for Brad, a record 1516 for the data object “f3” related to the user account for Brad, a record 1518 for the data object “j4” related to the user account for Darla, a record 1520 for the data object “c4” related to the user account for Darla, a record 1522 for the data object “n1” related to the user account for Darla, and a record 1524 for the data object “l2” related to the user account for Darla. For the user account for Brad, the application j4 can be a topic of frequent queries so that the application j4 can become a seed application of the “Brad's interests” cluster 1402, the applications f4 and n1 can be added to the “Brad's interests” cluster 1402 based on determinations of relationships with the application j4, and the application f3 can be added to the “Brad's interests” cluster 1402 as a result of a formal concept analysis process. Likewise, for the user account for Darla, the application j4 can be a topic of frequent queries so that the application j4 can become a seed application of the “Darla's interests” cluster 1404, the applications c4 and n1 can be added to the “Darla's interests” cluster 1404 based on determinations of relationships with the application j4, and the application l2 can be added to the “Darla's interests” cluster 1404 as a result of a formal concept analysis process.

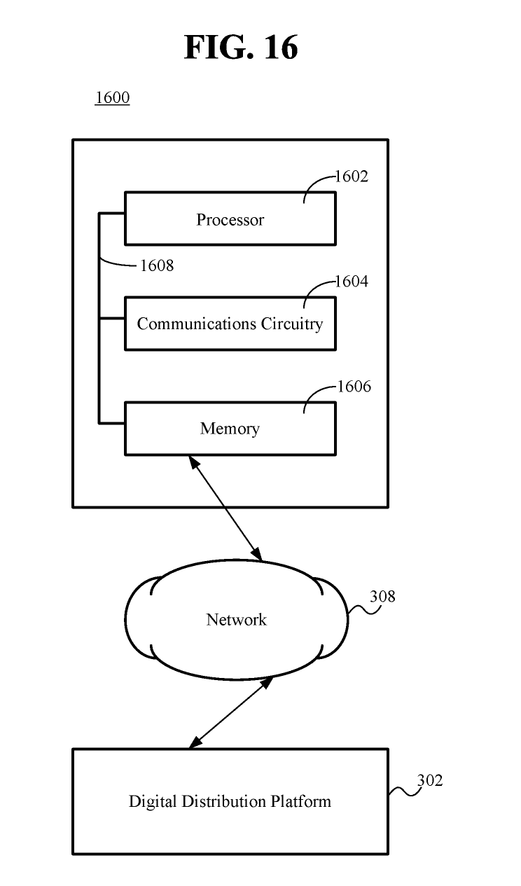

FIG. 16 is a block diagram illustrating an example of a system 1600 for producing a personalized selection of applications for presentation on a web-based interface according to the disclosed subject matter. In an aspect, the system 1600 can be an information retrieval platform (e.g., the information retrieval platform 104). The system 1600 can include, for example, a processor 1602, communications circuitry 1604, a memory 1606, and a bus 1608. The communications circuitry 1604 can be configured to provide communications between the system 1600 and devices external to the system 1600. The processor 1602 can include any processing circuit operative to control an operation of the system 1600. The communications circuitry 1604 can be configured to provide communications via a packet switched network, a cellular network, a satellite network, an optical network, a telephone link, the like, or any combination thereof. The communications circuitry 1604 can be configured to provide communications in a wired or a wireless manner. The communications circuitry 1604 can be configured to perform simultaneously several communications operations using different networks. The memory 1606 can include one or more storage media. For example, the memory 1606 can include at least one of a hard-drive, a solid state drive, optical drive, floppy disk, flash memory, read-only memory (ROM), random-access memory (RAM), cache memory, a Fibre Channel network, a storage area network (SAN), or any combination thereof. The bus 1608 can be coupled to the processor 1602, the communications circuitry 1604, and the memory 1606, and can be configured to facilitate communications among these components. Other devices and components (not illustrated) can also be included in the system 1600.

The processor 1602 can be configured to produce, through a word embedding process, a first vector. The first vector can represent one or more first words, the one or more first words can be from a first query. The first query can be a free-form text query. The word embedding process can include, for example: (1) a neural network process, (2) a process to reduce dimensions of a word co-occurrence matrix, (2) a process that uses a probabilistic model, (4) a process to represent the one or more first words in terms of a context in which the one or more first words are used, (5) the like, or (6) any combination thereof. A dimension of the first vector can include, for example: (1) a number of occurrences of the one or more first words in documents in a collection of documents, (2) another word and a displacement of the other word from one of the one or more first words in a context of a phrase, (3) the like, or (4) any combination thereof.

The processor 1602 can be configured to determine that a measure of similarity between the first vector and a second vector is greater than a first threshold. The second vector can represent one or more second words. The measure of similarity can include, for example: (1) a cosine similarity between the first vector and the second vector, (2) a product of the first vector multiplied by a weight, (3) the like, or (4) any combination thereof. A value of the weight can be determined, for example, by: (1) a part of speech of one of the one or more the first words (e.g., noun, pronoun, adjective, verb, adverb, preposition, conjunction, or interjection), (2) a number of occurrences of the first word in documents in a collection of documents, (3) the like, or (4) any combination thereof.

The processor 1602 can be configured to determine an existence of a relationship between a first application and a second application. The first application and the second application can be available for distribution by the digital distribution platform 302.

The processor 1602 can be configured to generate, in response to a first determination, a cluster of applications, the cluster of applications including the first application and the second application. The first determination can be of the existence of the relationship. The existence of the relationship can include, for example: (1) an indication that the first application was opened on a user device, associated with a user account associated with the first query, at a first time, and the second application was opened on the user device at a second time; (2) an indication that the first application was installed on the user device at a third time, and the second application was installed on the user device at a fourth time; (3) an indication that the first application and the second application are related to a same topic; (4) the like; or (5) any combination thereof. Optionally, the first time can be different from the second time, and the first time and the second time can be within a first duration of time. Optionally, the third time can be different from the fourth time, and the third time and the fourth time can be within a second duration of time.

The processor 1602 can be configured to produce, based on information about the cluster of applications, the personalized selection of applications for presentation on the web-based interface for a user account associated with the first query.

The communications circuitry 1604 can be configured to transmit, to the digital distribution platform 302 and in response to a second determination, a second query. The second query can include the one or more first words (from the first query) and the one or more second words (derived from the second vector). The second determination can be that the measure of similarity is greater than the first threshold.

The communication circuitry 1604 can be configured to receive, from the digital distribution platform 302, a response to the second query. The response to the second query can include an identification of the first application.

The memory 1606 can be configured to store the one or more first words, the first vector, the first query, the one or more second words, the second vector, the second query, the measure of similarity, the first threshold, the response to the second query, and the information about the cluster of applications.

Optionally, the processor 1602 can be further configured to retrieve the first query from the digital distribution platform 302.

Optionally, the processor 1602 can be further configured to produce a modified first query by: (1) changing a specific tense of a first specific word of the one or more first words, (2) changing a specific grammatical number of a second specific word of the one or more first words, (3) removing a stop word from the first query, (4) the like, or (5) any combination thereof. Optionally, the processor 1602 can be further configured to determine that a number of occurrences, in the digital distribution platform, of the modified first query is greater than a second threshold.

Optionally, the processor 1602 can be further configured to retrieve the second vector from a knowledge base. For example, a knowledge base can be a technology used to store complex structured and unstructured information used by a computer system. The knowledge base can include, for example, the Knowledge Graph (developed and maintained by Google Inc. of Mountain View, Calif.).

Optionally, the processor 1602 can be further configured to retrieve information about the second application from the digital distribution platform 302.

Optionally, the processor 1602 can be further configured to determine, through a formal concept analysis process, a concept of data objects for applications available for distribution by the digital distribution platform. The concept can include a set of data objects from a population of data objects. The set of data objects can be defined by a set of specific words included in an attribute field of each data object in the set of data objects.

Optionally, the processor 1602 can be further configured to retrieve, from the digital distribution platform 302, information from the data objects.

Optionally, the concept can include a merger of a first concept and a second concept.

For example, the processor 1602 can be further configured to produce the merger by: (1) calculating a first quotient of a number of words included in a set of specific words included in an attribute field of each data object included in both the first concept and the second concept divided by a number of words included in a set of specific words included in the attribute field of the each data object included in the first concept, (2) calculating a second quotient of the number of words included in the set of specific words included in the attribute field of the each data object included in both the first concept and the second concept divided by a number of words included in a set of specific words included in the attribute field of the each data object included in the second concept, and (3) producing, in response to a third determination, the merger. The third determination can be that at least one of the first quotient or the second quotient is greater than or equal to a third threshold.

Optionally, the processor 1602 can be further configured to modify, in response to a fourth determination, the cluster of applications to include the applications associated with the data objects included in the concept. The fourth determination can be that a word, of the set of specific words, matches at least one of the at least one first word or the at least one second word.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

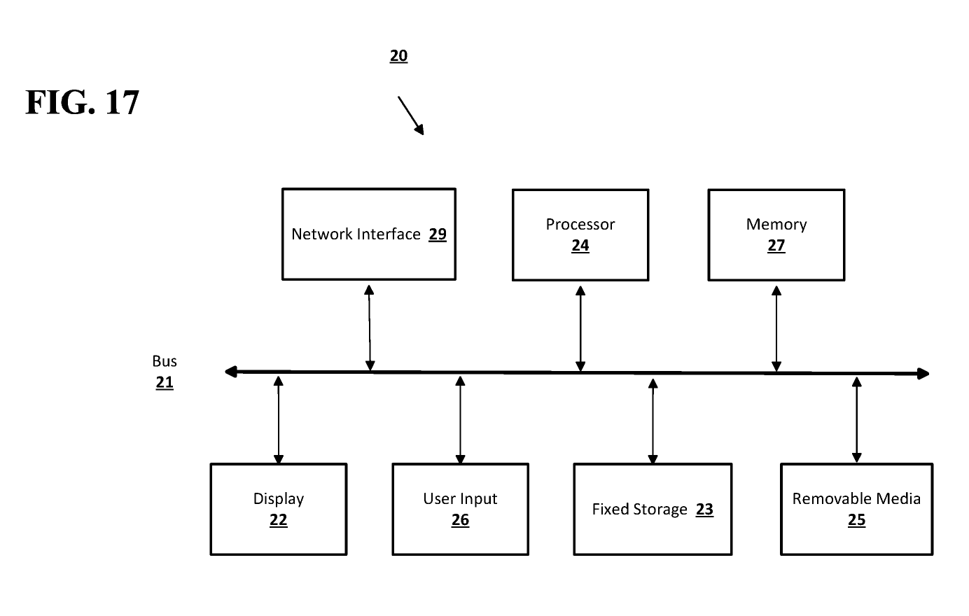

Aspects of the presently disclosed subject matter may be implemented in and used with a variety of component and network architectures. FIG. 17 illustrates an example computing device 20 suitable for implementing aspects of the presently disclosed subject matter. The device 20 can be, for example, a desktop or laptop computer, or a mobile computing device such as a smart phone, tablet, or the like. The device 20 can include a bus 21 (which can interconnect major components of the computer 20, such as a central processor 24), a memory 27 (such as random-access memory (RAM), read-only memory (ROM), flash RAM, or the like), a user display 22 (such as a display screen), a user input interface 26 (which can include one or more controllers and associated user input devices such as a keyboard, mouse, touch screen, and the like), a fixed storage 23 (such as a hard drive, flash storage, and the like), a removable media component 25 (operative to control and receive an optical disk, flash drive, and the like), and a network interface 29 operable to communicate with one or more remote devices via a suitable network connection.

The bus 21 can allow data communication between the central processor 24 and one or more memory components, which can include RAM, ROM, and other memory, as previously noted. Typically RAM can be the main memory into which an operating system and application programs are loaded. A ROM or flash memory component can contain, among other code, the basic input-output system (BIOS) which can control basic hardware operation such as the interaction with peripheral components. Applications resident with the computer 20 can generally be stored on and accessed via a computer readable medium, such as a hard disk drive (e.g., fixed storage 23), an optical drive, floppy disk, or other storage medium.

The fixed storage 23 can be integral with the computer 20 or can be separate and accessed through other interfaces. The network interface 29 can provide a direct connection to a remote server via a wired or wireless connection. The network interface 29 can provide such connection using any suitable technique and protocol as is readily understood by one of skill in the art, including digital cellular telephone, WiFi™, Bluetooth®, near-field, and the like. For example, the network interface 29 can allow the computer to communicate with other computers via one or more local, wide-area, or other communication networks, as described in further detail below.

Many other devices or components (not shown) can be connected in a similar manner (e.g., document scanners, digital cameras and so on). Conversely, all of the components illustrated in FIG. 17 need not be present to practice the disclosed subject matter. The components can be interconnected in different ways from that illustrated. The operation of a computer such as that illustrated in FIG. 17 is readily known in the art and is not discussed in detail in this application. Code to implement the disclosed subject matter can be stored in computer-readable storage media such as one or more of the memory 27, fixed storage 23, removable media 25, or on a remote storage location.

More generally, various aspects of the presently disclosed subject matter can include or be realized in the form of computer-implemented processes and apparatuses for practicing those processes. Aspects also can be realized in the form of a computer program product having computer program code containing instructions embodied in non-transitory and/or tangible media, such as floppy diskettes, CD-ROMs, hard drives, universal serial bus (USB) drives, or any other machine readable storage medium, such that when the computer program code is loaded into and executed by a computer, the computer becomes an apparatus for practicing aspects of the disclosed subject matter. Aspects also can be realized in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing aspects of the disclosed subject matter. When implemented on a general-purpose microprocessor, the computer program code segments configure the microprocessor to create specific logic circuits.

In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Aspects can be implemented using hardware that can include a processor, such as a general purpose microprocessor and/or an application-specific integrated circuit (ASIC) that embodies all or part of the techniques according to aspects of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to aspects of the disclosed subject matter.

The foregoing description, for purpose of explanation, has been described with reference to specific aspects. However, the illustrative discussions above are not intended to be exhaustive or to limit aspects of the disclosed subject matter to the precise forms disclosed. Many modifications and variations are possible in view of the above teachings. The aspects were chosen and described in order to explain the principles of aspects of the disclosed subject matter and their practical applications, to thereby enable others skilled in the art to utilize those aspects as well as various aspects with various modifications as may be suited to the particular use contemplated.

1. A method for producing a personalized selection of applications for presentation on a web-based interface, comprising:
producing, by a processor and through a word embedding process, a first vector, the first vector representing at least one first word, the at least one first word being from a first query, the first query being a free-form text query;
transmitting, from the processor to a digital distribution platform and in response to a first determination, a second query, the second query including the at least one first word and at least one second word, the first determination being that a measure of similarity between the first vector and a second vector is greater than a first threshold, the second vector representing the at least one second word;
receiving, by the processor and from the digital distribution platform, a response to the second query, the response to the second query including an identification of a first application, the first application being available for distribution by the digital distribution platform;
generating, by the processor and in response to a second determination, a cluster of applications, the cluster of applications including the first application and a second application, the second application being available for distribution by the digital distribution platform, the second determination being of an existence of a relationship between the first application and the second application; and
producing, by the processor and based on information about the cluster of applications, the personalized selection of applications for presentation on the web-based interface for a user account associated with the first query.

2. The method of claim 1, further comprising retrieving, by the processor and from the digital distribution platform, the first query.

3. The method of claim 2, further comprising producing, by the processor, a modified first query by at least one of:
changing a specific tense of a first specific word of the at least one first word,
changing a specific grammatical number of a second specific word of the at least one first word, or
removing a stop word from the first query.

4. The method of claim 3, further comprising determining, by the processor, that a number of occurrences, in the digital distribution platform, of the modified first query is greater than a second threshold.

5. The method of claim 1, wherein the word embedding process comprises at least one of:
a neural network process,
a process to reduce dimensions of a word co-occurrence matrix,
a process that uses a probabilistic model, or
a process to represent the at least one first word in terms of a context in which the at least one first word is used.

6. The method of claim 1, wherein a dimension of the first vector comprise at least one of:
a number of occurrences of the at least one first word in documents in a collection of documents, or
another word and a displacement of the other word from one of the at least one first word in a context of a phrase.

7. The method of claim 1, further comprising retrieving, by the processor and from a knowledge base, the second vector.

8. The method of claim 7, wherein the knowledge base comprises the Knowledge Graph.

9. The method of claim 1, wherein the measure of similarity comprises a cosine similarity between the first vector and the second vector.

10. The method of claim 1, wherein the measure of similarity includes a product of the first vector multiplied by a weight.

11. The method of claim 10, wherein a value of the weight is determined by at least one of:
a part of speech of one of the at least one first word, or
a number of occurrences of the one of the at least one first word in documents in a collection of documents.

12. The method of claim 1, further comprising retrieving, by the processor and from the digital distribution platform, information about the second application.

13. The method of claim 1, wherein the existence of the relationship comprises at least one of:
an indication that:
the first application was opened on a user device associated with the user account at a first time, and
the second application was opened on the user device at a second time, an indication that:
the first application was installed on the user device at a third time, and
the second application was installed on the user device at a fourth time, or
an indication that the first application and the second application are related to a same topic.

14. The method of claim 13, wherein at least one of:
the first time being different from the second time, and the first time and the second time being within a first duration of time, or
the third time being different from the fourth time, and the third time and the fourth time being within a second duration of time.

15. The method of claim 1, further comprising:
determining, by the processor and through a formal concept analysis process, a concept of data objects for applications available for distribution by the digital distribution platform, the concept including a set of data objects from a population of data objects, the set of data objects defined by a set of specific words included in an attribute field of each data object in the set of data objects; and
modifying, by the processor and in response to a third determination, the cluster of applications to include the applications associated with the data objects included in the concept, the third determination being that a word, of the set of specific words, matches at least one of the at least one first word or the at least one second word.

16. The method of claim 15, further comprising retrieving, by the processor and from the digital distribution platform, information from the data objects.

17. The method of claim 15, wherein the determining comprises merging a first concept and a second concept.

18. The method of claim 17, wherein the merging the first concept and the second concept comprises:
calculating a first quotient of a number of words included in a set of specific words included in an attribute field of each data object included in both the first concept and the second concept divided by a number of words included in a set of specific words included in the attribute field of the each data object included in the first concept;
calculating a second quotient of the number of words included in the set of specific words included in the attribute field of the each data object included in both the first concept and the second concept divided by a number of words included in a set of specific words included in the attribute field of the each data object included in the second concept; and
producing, in response to a fourth determination, the merger, the fourth determination being that at least one of the first quotient or the second quotient is greater than or equal to a second threshold.

19. A non-transitory computer-readable medium storing computer code for controlling a processor to cause the processor to produce a personalized selection of applications for presentation on a web-based interface, the computer code including instructions to cause the processor to:
produce, through a word embedding process, a first vector, the first vector representing at least one first word, the at least one first word being from a first query, the first query being a free-form text query;
transmit, to a digital distribution platform and in response to a first determination, a second query, the second query including the at least one first word and at least one second word, the first determination being that a measure of similarity between the first vector and a second vector is greater than a first threshold, the second vector representing the at least one second word;
receive, from the digital distribution platform, a response to the second query, the response to the second query including an identification of a first application, the first application being available for distribution by the digital distribution platform;
generate, in response to a second determination, a cluster of applications, the cluster of applications including the first application and a second application, the second application being available for distribution by the digital distribution platform, the second determination being of an existence of a relationship between the first application and the second application; and
produce, based on information about the cluster of applications, the personalized selection of applications for presentation on the web-based interface for a user account associated with the first query.

20. A system for producing a personalized selection of applications for presentation on a web-based interface, comprising:
a processor configured to:
produce, through a word embedding process, a first vector, the first vector representing at least one first word, the at least one first word being from a first query, the first query being a free-form text query;
determine that a measure of similarity between the first vector and a second vector is greater than a threshold, the second vector representing at least one second word;
determine an existence of a relationship between a first application and a second application, the first application and the second application being available for distribution by a digital distribution platform;
generate, in response to a first determination, a cluster of applications, the cluster of applications including the first application and the second application, the first determination being of the existence of the relationship; and
produce, based on information about the cluster of applications, the personalized selection of applications for presentation on the web-based interface for a user account associated with the first query;
communications circuitry configured to:
transmit, to the digital distribution platform and in response to a second determination, a second query, the second query including the at least one first word and the at least one second word, the second determination being that the measure of similarity is greater than the threshold; and
receive, from the digital distribution platform, a response to the second query, the response to the second query including an identification of the first application; and
a memory configured to store the at least one first word, the first vector, the first query, the at least one second word, the second vector, the second query, the measure of similarity, the threshold, the response to the second query, and the information about the cluster of applications.
